(19) United States
(12) Patent Application Publication
(10) Pub. No.: US 2010/0057938 A1
(43) Pub. Date: Mar. 4, 2010

(54) Method for Sparse Object Streaming in Mobile Devices

(76) Inventors: John Osborne, Incline Village, NV (US); James H. Schmidt, Incline Village, NV (US)

Correspondence Address: IAN F. BURNS & ASSOCIATES, 4790 Caughlin Parkway #701, RENO, NV, 89519-0907, US

(21) Appl. No.: 12/547,352

(22) Filed: Aug. 25, 2009

Related U.S. Application Data
(60) Provisional application No. 61/091,932, filed on Aug. 26, 2008.

(51) Int. Cl. G06F 15/16; G06F 17/30

(52) U.S. Cl. 709/246; 707/10; 707/E17.007

(57) ABSTRACT

A communication system includes a wireless communication device that is adapted to send and receive data associated with at least one application. A computer server is in communication with the wireless communication device. The computer server is adapted to determine a new set of data requested by the wireless communication device and to compare the new set of data to a previously transmitted set of data. A reduced set of data is generated. The reduced set of data comprises at least a portion of the new set of data not previously transmitted. The reduced set of data is transmitted to the wireless communication device. A method of generating a reduced or sparse data object is also disclosed.

### CROSS REFERENCE TO RELATED APPLICATIONS

This application claims priority to U.S. provisional patent application Ser. No. 61/091,932, filed Aug. 26, 2008. The entire contents of which are herein incorporated by reference.

### FIELD OF THE INVENTION

The present invention relates to data processing and wireless communication systems. More specifically, the present invention relates to systems and methods for the transmission of data objects over wireless communication networks.

### BACKGROUND

Wireless communication devices such as cell phones were originally designed primarily to handle analog voice communications. Since then, additional demands for the transmission and reception of digital data have been placed on wireless networks. For example, digital data such as short message service (SMS), multimedia message service (MMS), application middleware, and World Wide Web browsers have steadily increased the role and demand of digital data in mobile devices. Because of the restricted communication bandwidth and storage limitations that exist between wireless networks and wireless devices, the mobile devices often suffer reduced Quality of Service (QoS) or delays when displaying data or forms associated with web pages or applications which depend on remote data. The reduced QoS can result in the incomplete transmission of data for web pages, messages or other mobile applications.

### SUMMARY OF ONE EMBODIMENT OF THE INVENTION

### Brief Description of One Embodiment of the Present Invention

In one embodiment, the present invention comprises a communication system that includes a wireless communication device that is adapted to send and receive data associated with at least one application. A computer server is in communication with the wireless communication device. The computer server is adapted to determine a first set of data requested by the wireless communication device and to compare the first set of data to a second previously transmitted set of data. A third set of data is generated. The third set of data comprises at least a portion of the first set of data not previously transmitted. The third set of data is transmitted to the wireless communication device.

In another embodiment, the present invention comprises a computerized method. The method includes determining a new data object to be transmitted and comparing the new data object to a previously transmitted data object. A reduced data object is generated. The reduced data object comprises at least a portion of the new data object not previously transmitted. The reduced data object is transmitted.

In an additional embodiment, the present invention comprises a machine-readable medium comprising instructions, which when implemented by a computer performs the following operations: A new data object is determined to be transmitted. The new data object is compared to a previously transmitted data object. A reduced data object is generated. The reduced data object comprises at least a portion of the new data object. A member map is generated. The member map contains a listing of data objects that are modified and data objects that are unmodified.

In yet another embodiment, the present invention comprises a communication system. The communication system includes a wireless communication device that is adapted to send and receive data associated with at least one application. A computer server is in communication with the wireless communication device. The computer server has a processor. Software is operable on the processor to determine a first set of data to be transmitted and to compare the first set of data to a second previously transmitted set of data. A third set of data is generated. The third set of data comprises at least a portion of the first set of data not previously transmitted. The third set of data is transmitted to the wireless communication device.

In one more embodiment, the present invention comprises a computerized method. The method includes determining a new data object to be transmitted and comparing the new data object to a set of default data object values. A reduced data object is generated. The reduced data object comprises at least a set of non-default data object values. The reduced data object is transmitted.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### ADVANTAGES OF ONE OR MORE EMBODIMENTS OF THE PRESENT INVENTION

The various embodiments of the present invention may, but do not necessarily, achieve one or more of the following advantages:

The ability to provide sparse data objects that require less wireless network bandwidth to transmit to a wireless communication device;

The ability to create a member map of default and non-default data object members;

The ability to generate a reduced data object;

The ability to cache default and previously sent data in a wireless communication device;

The ability to compare a current data object with default values of the data object;

The ability to compare a current data object with previously sent data objects;

The ability to decode a member map;

The ability to generate and transmit a reduced data object and member map to a wireless device;

The ability to enable an application running on a wireless device using less bandwidth and fewer wireless network resources;

The ability for a wireless communication device to generate a sparse data object;

The ability to compare data objects, determine previously sent or default data object members and generate a reduced or sparse data object for transmission.

These and other advantages may be realized by reference to the remaining portions of the specification, claims, and abstract.

### BRIEF DESCRIPTION OF THE DRAWINGS

FIG. 1 is substantially a diagrammatic view of a wireless communication network in accordance with the present invention.

FIG. 2 is substantially a diagrammatic view of a computer server.

FIG. 3 is substantially a diagrammatic view of a wireless communication device.

FIG. 4A is substantially an example of a reduced or sparse data object and member map.

FIG. 4B is substantially an example of a reduced or sparse data object and member map.

FIG. 5 is substantially a flowchart of a method for determining, generating and transmitting reduced or sparse data objects of the present invention.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

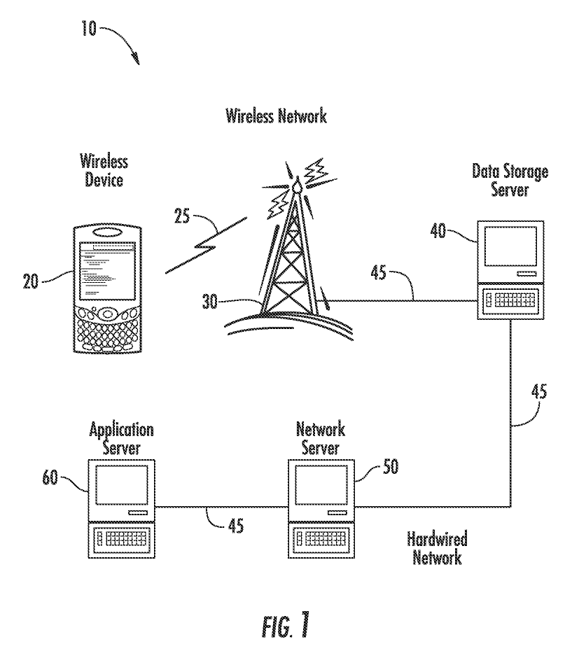

Referring to FIG. 1, a communication system 10 is shown. Communication system 10 can include a mobile or wireless communication device 20, a wireless network 30, a data storage server 40, a network server 50 and an application server 60.

Mobile communication device 20 can be a wide variety of wireless communication devices such as personal data assistants, mobile telephones, laptop computers, pagers, email devices and netbooks. Wireless network 30 can be in communication with mobile communication device 20 through a wireless signal 25. Wireless network 30 can send and receive wireless signals 25. Wireless network 30 can use a wide variety of communication protocols and systems and can include, but is not limited to PCS, GSM, TDMA, CDMA, Internet Protocol (IP) network, Wireless Application Protocol (WAP) network, a WiFi network, bluetooth or a local area network (LAN).

Wireless network 30 can be in communication with data storage server 40 through a hardwired network 45. Hardwired network 45 can include a wide variety of hardwired communication devices and transmission mediums such as metal or optical cables and other terrestrial based communication systems. Data storage server 40 can also communicate with network server 50 and an application server 60 through hardwired network 45. Data storage server 40 can store, send and receive a wide variety of data, programs and communications. Network server 50 may control one or more data storage servers that cause application programs and data to be routed from application server 60 to data storage server 40.

Application server 60 can contain a wide variety of applications, software programs and instructions that can be executed, downloaded or run on wireless device 20. For example, internet programs or messaging programs and data may be transmitted from application server 60 to wireless device 20. Wireless device 20 may also request, send and receive data and programs from application server 60.

In one embodiment, wireless network 30, data storage server 40, network server 50 and application server 60 may exist entirely within a single device, where minimizing transmission overhead and data packets would be advantageous between the various subsystems.

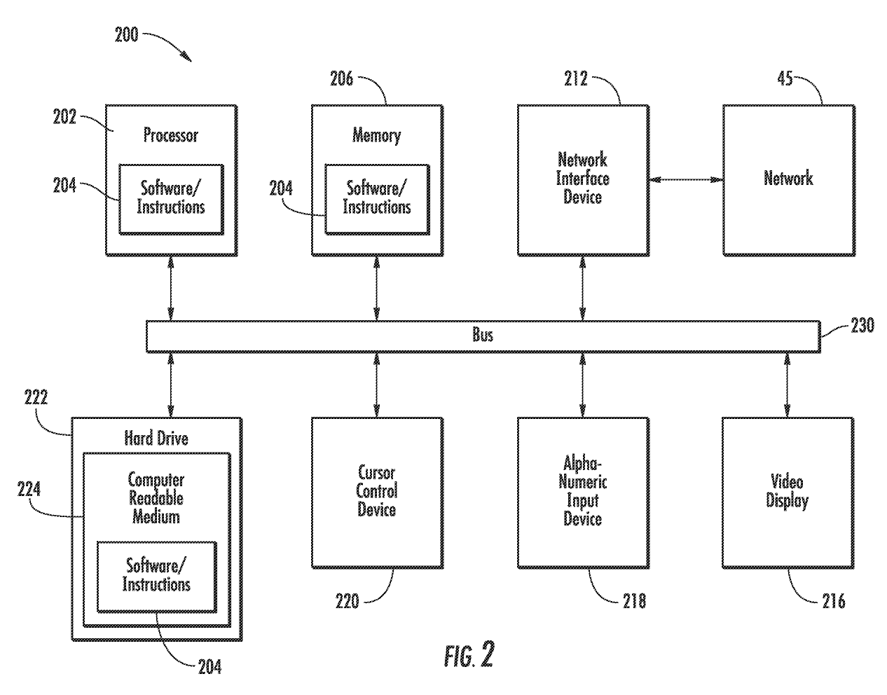

With reference to FIG. 2, a block diagram of a computer server 200 such as data storage server 40, network server 50 or application server 60 is shown. Computer server 200 may execute a set of instructions or software programs that cause any one or more of the methods, processes, operations, applications, or methodologies discussed herein to be performed.

In a networked embodiment, computer server 200 may operate in a server-client network environment, or as a peer machine in a peer-to-peer (or distributed) network environment.

Computer server 200 can include a processor or central processing unit 202 and a main memory 206, which communicate with each other via a bus 230. The computer server 200 further includes a video display 216, an alphanumeric input device 218, a cursor control device 220 such as a mouse, a hard drive unit 222 and a network interface device 212.

The drive unit 222 includes a machine-readable medium 224 on which is stored one or more sets of instructions such as software programs 204 that include any one or more of the methodologies or functions described herein. The software 204 may also reside, completely or at least partially, within the main memory 206 and/or within the processor 202 during execution thereof by the computer server 200. The main memory 206 and the processor 202 also comprise machine-readable media. The software 204 may include data objects and applications that can be transmitted or received over network 45 via the network interface device 212.

While the machine-readable medium 224 is shown in an example embodiment to be a single medium, the term, “machine-readable medium”, should be taken to include a single medium or multiple medium such as a centralized or distributed database, and/or associated caches and servers that store one or more sets of instructions. The term, “machine-readable medium”, shall also be taken to include any medium that is capable of storing, encoding or carrying a set of instructions for execution by the machine and that cause the machine to perform any one or more of the methodologies shown in the various embodiments of the present invention. The term, “machine-readable medium”, shall accordingly be taken to include, but not be limited to, solid-state memories, optical and magnetic media, and carrier wave signals.

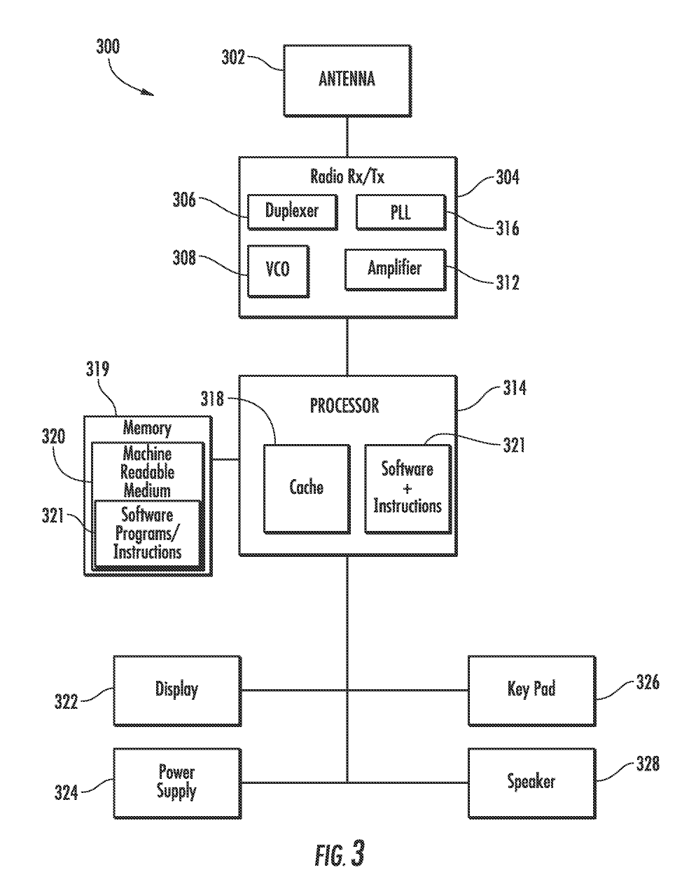

Turning now to FIG. 3, a diagrammatic view of a wireless communication device 300 such as wireless device 20 of FIG. 1 is shown. An example of a mobile device for use with the methods and systems described herein is a self-powered wireless device capable of a wide-area or local wireless communication with a plurality of other of hand-held, mobile, self-powered wireless devices or with communication networks such as base stations that are at a fixed location. The hand-held, mobile, self-powered wireless device can contain a memory, a human input device, a display and a processor. The memory can store a plurality of data relating to applications, data objects and other data.

Communication device 300 can comprise an antenna 302, a radio section 304, a processor 314 and a memory 320. Radio section 304 includes a duplexer 306, voltage controlled oscillator (VCO) 308, phase lock loop circuit (PLL) 310 and an amplifier 312. Duplexer 306 is in communication with antenna 302. Duplexer 306, VCO 308, PLL 310 and an amplifier 312 are in communication with each other. Radio section 304 can transmit and receive RF signals that contain data objects and applications through antenna 302. Any signals received by antenna 302 are processed by radio 304. The processing may include amplification and filtering of the radio frequency signals and analog to digital conversion of any data and information received.

Radio section 304 is in communication with processor 314. Processor 314 can include a memory cache 318 for the storage of frequently used data and software and instructions 321 that may reside in processor 314 for execution on processor 314. Memory 319 is in communication with processor 314. Memory 319 can be a wide variety of memory devices such as flash memory, RAM, ROM or EPROM memory devices.

Memory 319 may include a machine-readable medium 320 on which is stored one or more sets of instructions such as software programs 321 that include any one or more of the methodologies or functions described herein. The software 321 may also reside, completely or at least partially, within the cache 318 and/or within the processor 314 during execution thereof. The software 321 may include data objects and applications that can be transmitted or received with data storage server 40 (FIG. 1) over the wireless network 30 (FIG. 1).

Communication device 300 may further comprise a display 322 such as an LCD display, a keypad 326 for inputting commands and information, a speaker 328 and a power supply 324.

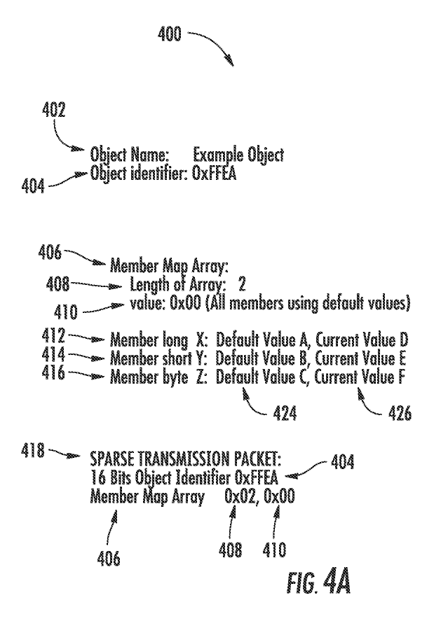

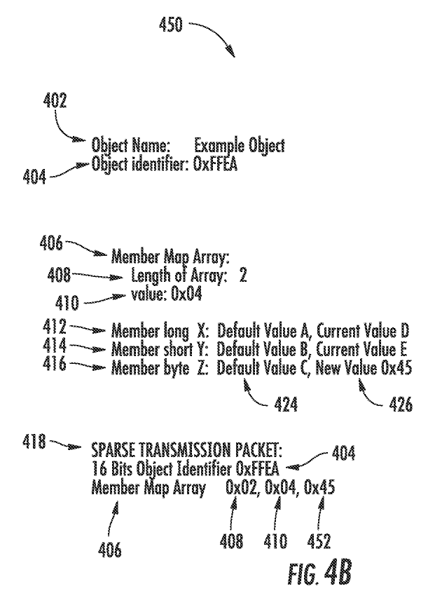

Referring now to FIG. 4A, a reduced or sparse data object, set of data and member map 400 are shown. In FIG. 4A, an example is shown of an object oriented data structure and its members for use with reduced or sparse data transmission. The data object may have a naming convention such as a data object name 402.

The term “data object” in the present invention is more generic than object oriented programming (OOP) data objects. The term “data object” in the present invention can be defined to include simpler data structures, arrays, and structured lists. The data object can be a predefined collection of data elements, types and values such that different software packages have a mechanism or mapping that enables them to read and write the data within the collection without error.

In FIG. 4A, the data object name is, “Example Object”. The data object also has a unique identifier such as data object identifier 404. In FIG. 4A, the data object identifier is, “0xFFEA”. The data object identifier 404 is known to both the data storage server 40 (FIG. 1) and the application program running on wireless device 20.

Member map array 406 may be either a fixed length bit value, such as a 16 or 32 bit integer, or an array of bytes where the first byte is the byte array length. It is understood that there may be a wide variety of implementations for the member map array 406 that accomplish equivalent results. Member map array 406 can include a length of array 408 and a value 410. In FIG. 4A, the length of array 408 is shown as, “2” and the value 410 is shown as, “0x00”. The value of “0x00” correlates to all of the data members having no changes and using the default values assigned to the data object.

Within the data object 400, each member may be defined by its storage requirement. The members include member values for a long member 412, short member 414 and byte member 416. Each of the data members in the data object has a default value 424 and a current value 426 that are stored in the data object 400.

In FIG. 4A, long member X 412 has a default value 424 of “A” and a current value 426 of “D”. Short member Y 414 has a default value 424 of “B” and a current value 426 of “E”. Byte member Z 416 has a default value 424 of “C” and a current value 426 of “F”.

A sparse transmission packet 418 can be generated by either wireless device 20 (FIG. 1) or one or more of servers 40, 50 or 60 (FIG. 1). When the data values 424 or 426 of the data object are to be transmitted to the application, the sparse transmission packet need only contain the object identifier 404 and the member map 406 in a member array 408, 410 or member value 412, 414, 416 format. In the embodiment of FIG. 4A, all of the default values for the data members are used. The data object identifier 404 is “0xFFEA” and the member map array 406 is 0x02, 0x00. Member map array 406 comprises two bytes including the length of array 408 and a single byte of zero array value 410 bits indicating that no values are being transmitted. The entire data object 400 comprises four bytes.

The sparse object or transmission packet 418 that is transmitted would contain the bytes 0xFFEA, 0x02, 0x00. All of the data members are decodable at the receiving end by the wireless device.

With reference to FIG. 4B, another example of a reduced or sparse data object, set of data and member map 450 is shown. In FIG. 4B, a new value for a data member is used instead of a default value. Member Byte Z 416 will not contain a default or current value, but contains a new value to be transmitted. The new value 426 of member byte Z 416 is “0x45”.

The same data object identifier 404 of “0xFFEA” and length of array 408 of “2” are used. The member map array value 410 is changed to a new value of “0x04”. The sparse object or transmission packet 418 that is transmitted would contain the object identifier 404, “0×FFEA”, the length of the array value 408, “0x02”, and the bit in the member map array value 410 that corresponds to member byte Z 416, the data value that will be changed. As there are 3 values in the data object, X=bit 0, Y=bit 1 and Z=bit 2 in the member map array. The resulting member map value 410 is therefore a binary “00000100” or a hexadedimal “0x04”. A new byte 452 is then added to the data object which is the new value of byte Z. For example, if the new value of byte Z is “0x45”, The total sparse object or transmission packet 418 that is transmitted would contain: “0xffea, 0x02, 0x04, 0x45”.

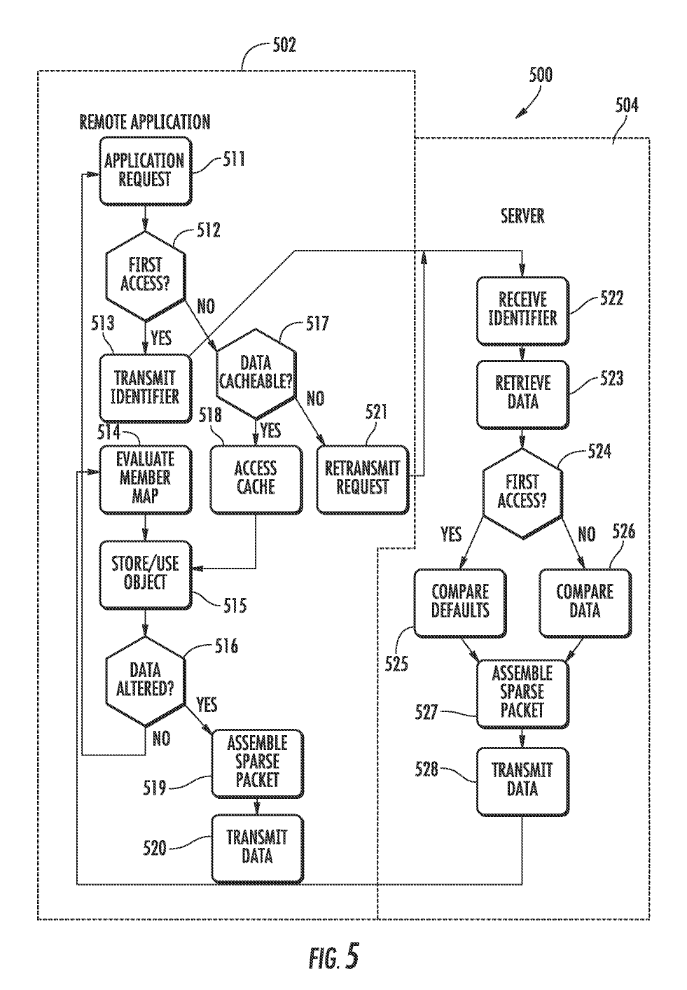

Turning now to FIG. 5, a flowchart of a method 500 for determining, generating and transmitting reduced or sparse data objects in accordance with the present invention is shown. At least a portion of method 500 can be programmed as software 204 stored in memory 206 or drive unit 222 and run on processor 202 of computer server 200 (FIG. 2). Another portion of method 500 can be programmed as software 321 stored in memory 319 and run on processor 314 of wireless communication device 300 (FIG. 3).

Method 500 is part of a dynamic real time optimization routine to reduce the number of bytes of data transmitted between a wireless communication device and a network server for various applications. Method 500 can determine which data values in a data object are redundant, have been previously been sent or are default values and generate a new reduced or sparse data object to be transmitted. Method 500 may perform some or all of the following steps in an order which may not be in the order listed.

In FIG. 5, the procedures, routines or steps of method 500 are divided into two portions. Steps 502 can be executed on a wireless communication device 20 (FIG. 1) or 300 (FIG. 3). Steps 504 can be executed on computer server 40, 50 or 60 (FIG. 1) or 300 (FIG. 3).

At step 511 an application that is running or to be run on a wireless communication device requests data from an external source such as a computer server. The requested data can be labeled a new set of data or a new data object. It is noted that the label, “new”, in this instance can have the meaning of new in the current application program routine cycle. At least a portion of the new data may have been previously used in previous application program routines or cycles. Next, method 500 determines if the request for data for the application is a first request for data in decision step 512. If the request for data for the application is first request for data, method 500 proceeds to step 513. If the request for data for the application is not the first request and has previously been requested, method 500 proceeds to step 517.

At step 513, a communication connection is established to the computer server and an identifier unique to this data object and known to the computer server, the communication device and the application is transmitted to the computer server. The identifier is received by the computer server at step 522. In response to this data request, the data object associated with the identifier and all of its members are retrieved from a computer server storage location in step 523.

Next, method 500 determines if this is the first time that the retrieved data object has been accessed or if the data object has been previously accessed in decision step 524. If the request for the data object is a new or first access of the data object, method 500 proceeds to step 525. If the request for data object is not new and has previously been accessed, method 500 proceeds to step 526.

At step 525, the current data object members are compared against the default values for those data object members. In one embodiment, the data object may be the screen size or font size for a cell phone display. In one embodiment, the computer server and the wireless communication device both contain the default values for the particular application that is to be executed on the wireless communication device. In step 525, the current members of the new data object are compared to the default values of the data object to ensure that no discrepancies are contained in the data object contents. After step 525, method 500 proceeds to step 527.

After the initial request for the data object, subsequent requests evaluate the data members against the known last, old or previous data member values and transmit only the changed values with the member map set to indicate the changed values. This task is performed in step 526.

At step 526 the current data object members or new set of data are compared against the previously sent values for those data object members or previously transmitted set of data. In one embodiment, the data object may be the screen size or font size for a cell phone display. In step 526, the new members of the data object are determined and the old previously sent members of the data object are determined. After step 526, method 500 proceeds to step 527.

In step 527, a reduced data object, reduced set of data or sparse transmission packet is assembled or generated. The reduced data object, reduced set of data or sparse transmission packet contains the member map and the data object values that are not a match to the default values or that were not previously sent. In other words, the reduced data object or sparse transmission packet contains the member map and any brand new data object members. In the case where all of the values are default values, the reduced data object only contains the member map. It is noted that the label “reduced” or “sparse” in this instance can have the meaning of lesser or fewer bytes or bits of information than if all of the data object values were included. Next, method 500 sends or transmits the reduced data object or sparse transmission packet from the computer server to the wireless communication device at step 528.

Upon receipt of the reduced data object or sparse transmission packet by the wireless communication device at step 514, method 500 evaluates and decodes the member map to determine the new values, the previously sent values and the default values. Next, in step 515, the wireless communication device then stores for each data object either the newly transmitted data object value or the default data object value that is associated with the particular data object identifier for that application. At this point the data object is ready for use in step 515 by the application being executed on the wireless communication device.

Returning now to step 512, if the request for data for the software application is not new and has previously been requested, method 500 proceeds to decision step 517. At decision step 517, method 500 determines if the data object can be cached or stored in a local memory location of the wireless communication device. If the data object can be cached or stored, method 500 proceeds to step 518. If data object cannot be cached or stored, method 500 proceeds to step 521.

In step 518, the data object may then be cached or stored within the wireless communication device and repeatedly used by the software application in step 515. After step 518, method 500 returns to step 515.

If the data object contains information or data that is not able to be cached and that may be altered by an external source, a flag is set in the data object member in step 521 indicating that one or more members are non-cacheable and the application must repeatedly request that data object from the external source or server. Step 521 also includes retransmitting the request for the data object to the computer server. After step 521, method 500 returns to step 522.

After the data object has been used in step 515 by an application running on the wireless communication device, method 500 proceeds to decision step 516 where the data objects are checked or compared to see if they have been altered or changed from the default or previous values. If a data object member is modified by the user or the application in the wireless communication device in such a way that permanent storage of the new member value is required, method 500 proceeds to step 519. If the data object member is not modified by the user or the application, method 500 returns the member map to step 514 where the member map is decoded.

At step 519, the member map is set to indicate the changed values and a reduced data object or sparse transmission packet is assembled or generated. The reduced data object or sparse transmission packet contains the member map and only those data object member values that have been changed by the wireless communication device. Next, the reduced data object or sparse transmission packet is transmitted to the computer server in step 520. At the computer server, the member map is used to update the proper data object values into permanent storage.

The use of method 500 has several advantages. Method 500 generates sparse or reduced data objects or transmission packets. The sparse or reduced data objects take up less storage space and require less transmission bandwidth to be transmitted to a wireless device. Thereby, the transmission of applications and application data to wireless devices can be completed in a faster, more efficient manner.

In various cellular telephone and wireless communication areas, communication bandwidth is limited and storage limitations exist between the wireless networks and wireless devices, resulting in Quality of Service (QoS) problems. Examples of Qos problems are delays when displaying data or forms associated with web pages or applications which depend on remote data resulting in the incomplete transmission of data for web pages, messages or other mobile applications. Frequently, these delays may result in error messages and stalled or locked application programs that must be restarted or rebooted in order to function. Method 500 can help the functionality of wireless application programs by minimizing the amount of data transmitted and reducing the amount of data that is required to be transmitted for applications.

Because of restricted communications bandwidth and storage, mobile communication devices often suffer reduced Quality of Service (QoS) or delays when displaying data or forms associated with web pages or software applications which depend on remote data. Embodiments of the invention disclose a method for transmitting data as objects having known or stored default values that are associated with each member so that only data that has changed or is not the default value is transmitted. The reduced data to be transmitted can significantly reduce network and processing overhead, connections, and provide higher quality of server for the mobile and wireless applications.

In one embodiment of the present invention, a software application is requesting data from a network resource. The external data may be permanent or calculated and delivered in real time. With reference to FIG. 1, the data object and its members being requested are known to both the application running on wireless device 20 and the delivery resource such as computer server 40. The delivery resource, however, may not know at this time what values, if any, are already cached at the requesting wireless device 20. Both the application running on wireless device 20 and the computer server 40 know, however, what the default values of the data members will be.

The data object also contains a member map 406 (FIG. 4A), where each data member is associated with one bit in the map. As the computer server begins transmission of the data for the object, it does at least know whether it is sending default or non-default values. The transmission stream is then reduced, by only transmitting non-default values. The member map is updated so that members which are transmitted are set with a binary 1, and members which will take default values and are not transmitted are given a value of binary 0.

If the same data object member is requested again, computer server 40 now knows the last values transmitted to wireless device 10 and the sparse transmission software program or routine may be extended so that unchanged values are not transmitted. If values of the data object are changed by the user of wireless device 10 or the software application running on wireless device 10, these are transmitted back to computer server 40, again with the member map set to indicate only those changed values that are being transmitted. Computer server 40 can then synchronize this changed data values with the last known values of the data object members.

In an embodiment, a software application running on wireless device 20 can connect to a wireless network 30 to request data from an external data server/storage device 40. The data structure and members of the object being requested are known to both software program or application running on the storage server 40 and the software application running on wireless device 20. The application running on data storage server 40, however, may not know the current state of the data object members in the mobile application running on wireless device 20. Both wireless device 20 and server 40, however, do know the default values of each data object member in the particular data object.

On the first request of the data object from wireless device 10, data storage server 40 may transfer only non-default values by setting a bit in the member map 410 (FIG. 4A) of the data object to indicate which data object members are being transferred and a “0” to indicate which data object members will be set to their default values. Subsequent requests of the same data object can then include only the values for the data object members which have changed, without the need to request the known values of the data object members from wireless device 20.

The use of transmission of sparse or reduced data objects is particularly useful where the requesting software application is running on a processor or wireless device architecture where reduced connectivity and transmission would be advantageous.

In another embodiment, the data transmission medium may be any network, wired or wireless device that ties the requesting software application to a remote server/storage device that provides the data object. In one embodiment, the software application and the computer server may run on the same system with no network. The use of the data reduction or compression method of the present invention can reduce the bandwidth of the internal connections between the server and other storage devices. The use of sparse data objects can increase the internal performance of computer systems.

In an embodiment, a method is provided where the data object, its members, and their default values are described in a markup language initially loaded by the software application from a remote server to the wireless device, and this description is used by both the server and the software application on the wireless device to subsequently utilize sparse transmission in the transfer of a plurality of data objects.

In an additional embodiment, the data object, its members, and their default values are described in a generic data object type known to both the computer server 40 and the software application on wireless device 20. This data object can be used to describe other data objects such that this description is used by both the computer server 40 and the application running on wireless device 20 to subsequently utilize sparse transmission in the transfer of the new data object.

In one more additional embodiment, the present invention can provide a method where any changed information in the software application running on wireless device 10 is first transferred via sparse transmission to the data storage server 40 such that only information not synchronized after this first transmission needs to be transmitted back to the wireless device 10. In this embodiment, as the server 40 may not have permanent storage of the current state of every wireless device connected in the network, the initial member map would again indicate that values transmitted are non-default values. This methodology can be useful if the uplink and downlink transmission capabilities of network 30 are asymmetric, such that uplinks are faster or less costly than downlinks. Subsequent downlinks from the server 40 would transmit only changed values as indicated by the member map.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

We claim:

1. A communication system comprising:
(A) a wireless communication device adapted to send and receive data associated with at least one application;
(B) a computer server in communication with the wireless communication device, the computer server being adapted to:
(a) determine a first set of data requested by the wireless communication device;
(b) compare the first set of data to a second previously transmitted set of data;
(c) generate a third set of data, the third set of data comprising at least a portion of the first set of data not previously transmitted; and
(d) transmit the third set of data to the wireless communication device.

2. The communication system of claim 1, wherein the computer server generates a first member map.

3. The communication system of claim 2, wherein the first member map comprises a listing of default data and non-default data associated with the application.

4. The communication system of claim 2, wherein the first member map is transmitted with the third set of data.

5. The communication system of claim 1, wherein the wireless communication device generates a second member map that is transmitted to the computer server.

6. The machine readable medium of claim 2, wherein the wireless communication device generates the first set of data from the third set of data and at least a portion of the second set of data using the first member map.

7. A computerized method, not necessarily in the order shown comprising:
(A) determining a new data object to be transmitted;
(B) comparing the new data object to a previously transmitted data object;
(C) generating a reduced data object, the reduced data object comprising at least a portion of the new data object not previously transmitted; and
(D) transmitting the reduced data object.

8. The computerized method of claim 7, further comprising generating a member map, the member map containing a listing of default data and non-default data associated with an application.

9. The computerized method of claim 8, further comprising transmitting the member map.

10. The computerized method of claim 7, further comprising caching redundant data object values.

11. The computerized method of claim 8, further comprising modifying the member map to indicate non-redundant data.

12. A machine-readable medium comprising instructions, which when implemented by a computer performs the following operations:
(A) determine a new data object to be transmitted;
(B) compare the new data object to a previously transmitted data object;
(C) generate a reduced data object, the reduced data object comprising at least a portion of the new data object; and
(D) generate a member map, the member map containing a listing of data objects that are modified and data objects that are unmodified.

13. The machine readable medium of claim 12, wherein the reduced data object and the member map are transmitted to a wireless communication device.

14. The machine readable medium of claim 12, wherein the wireless communication device generates the new data object from the reduced data object and at least a portion of the previously transmitted data object using the member map.

15. The machine readable medium of claim 12, wherein the wireless communication device generates a second reduced data object.

16. The machine readable medium of claim 15, wherein the second reduced data object is transmitted to a computer server.

17. The machine readable medium of claim 12, wherein the wireless communication device generates a second member map.

18. The machine readable medium of claim 17, wherein the second member map is transmitted to a computer server.

19. A communication system comprising:
(A) a wireless communication device adapted to send and receive data associated with at least one application;
(B) a computer server in communication with the wireless communication device, the computer server having a processor;
(C) software operable on the processor to:
(a) determine a first set of data to be transmitted;
(b) compare the first set of data to a second previously transmitted set of data;
(c) generate a third set of data, the third set of data comprising at least a portion of the first set of data not previously transmitted; and
(d) transmit the third set of data to the wireless communication device.

20. The communication system of claim 19, further comprising generating a first member map.

21. The communication system of claim 20, wherein the first member map comprises a listing of default data and non-default data associated with the application.

22. The communication system of claim 20, wherein the first member map is transmitted with the third set of data.

23. The communication system of claim 19, wherein the wireless communication device generates a second member map that is transmitted to the computer server.

24. The machine readable medium of claim 19, wherein the wireless communication device generates the first set of data from the third set of data and at least a portion of the second set of data using the first member map.

25. The machine readable medium of claim 19, wherein the first member map indicates at least one default value.

26. A computerized method, not necessarily in the order shown comprising:
(A) determining a new data object to be transmitted;
(B) comparing the new data object to a set of default data object values;
(C) generating a reduced data object, the reduced data object comprising at least a set of non-default data object values; and
(D) transmitting the reduced data object.

27. The computerized method of claim 26, further comprising generating a member map, the member map containing a listing of at least one default data object member and at least one non-default data object member.

28. The computerized method of claim 27, further comprising transmitting the member map.
